(19) United States
(12) Patent Application Publication
(10) Pub. No.: US 2009/0315416 A1
(43) Pub. Date: Dec. 24, 2009

(54) Motor with Heat Dissipation Arrangement

(76) Inventor: Yu-Ta Tu, Taipei City (TW)

Correspondence Address: David Shung, P.O. Box 10557, Taipei, 100, TW

(21) Appl. No.: 12/486,007

(22) Filed: Jun. 17, 2009

(30) Foreign Application Priority Data
Jun. 20, 2008 (TW) 097210900

(51) Int. Cl. H02K 9/197

(52) U.S. Cl. 310/54

(57) ABSTRACT

The motor with heat dissipation device includes a motor body, a housing covering the motor body, a cooling water tank and a pump. The housing is provided with a water outlet and a water inlet, which connect with the cooling water tank. The pump is arranged between the water inlet and cooling water tank. A water room is provided between the motor body and housing. The pump draws water from the cooling water tank and pushes it into the water room through the water inlet. The water in the water room absorbs heat of the motor body and goes back to the cooling water tank to finish a cycle.

### Background of the Invention

1. Technical Field

The invention generally relates to motors, particularly to motors with heat dissipation device.

2. Related Art

Motors are a primary power source in modern industry. Motors have been extensively applied because of low noise and no pollution. Motors rotate by means of electromagnetic field. Both current and resistance must result in heat. The larger the current is, the heavier the heat is. Long-term use will accumulate a large quantity of heat, which reduces performance of motors.

Prior arts usually utilize air flow to dissipate heat of motors. However, heat exchange by air flow must be implemented in a circumstance with certain temperature. Not all circumstances can be applied. This is the reason why the prior arts using air flow have not been broadly employed.

### SUMMARY OF THE INVENTION

A primary object of the invention is to enhance performance of heat dissipation of motors by using circulatory water.

To accomplish the above object, the motor with heat dissipation device according to the invention includes a motor body, a housing covering the motor body, a cooling water tank and a pump. The housing is provided with a water outlet and a water inlet, which connect with the cooling water tank. The pump is arranged between the water inlet and cooling water tank. A water room is provided between the motor body and housing. The pump draws water from the cooling water tank and pushes it into the water room through the water inlet. The water in the water room absorbs heat of the motor body and goes back to the cooling water tank to finish a cycle.

Besides, a fan can be additionally installed on the shaft of motor to rotate therewith. By rotation of the fan, outside air can be guided into the motor to absorb a part of heat generated from the motor for dissipation. The air cooling and water cooling can form a complex cooling mechanism to further improve effect of heat dissipation.

### BRIEF DESCRIPTION OF THE DRAWINGS

The teachings of the present invention can be readily understood by considering the following detailed description in conjunction with the accompanying drawings, in which:

FIG. 1 depicts a systematic block diagram of the invention;

FIG. 2 depicts an exploded view of the motor of the invention; and

FIG. 3 depicts another embodiment of the motor of the invention.

### DETAILED DESCRIPTION OF THE INVENTION

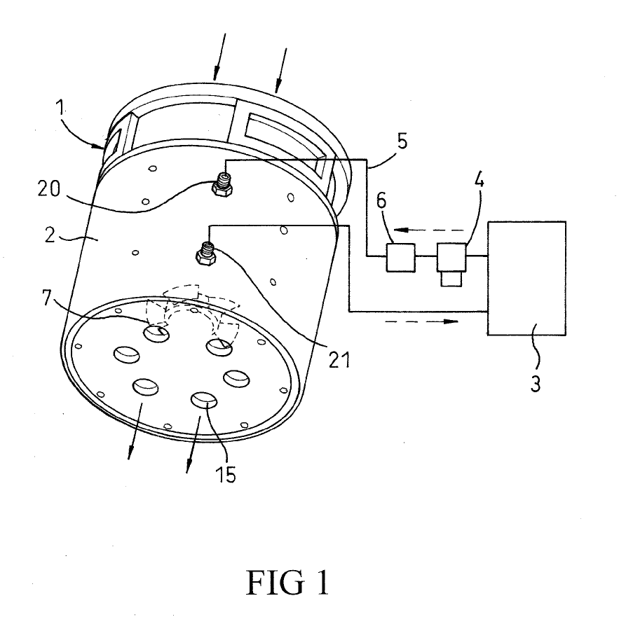

Referring to FIG. 1, the invention includes a motor body 1, a housing 2 covering the motor body 1, a cooling water tank 3 and a pump 4. The housing 2 is provided with a water outlet 21 and a water inlet 20. Both the water outlet 21 and water inlet 20 connect with the cooling water tank 3 to form a loop. The pump 4 is arranged between the water inlet 20 and cooling water tank 3.

The housing 2 seals up the motor body 1. A water room 1a is provided between the motor body 1 and housing 2. When the motor body 1 is rotating, the pump 4 draws water from the cooling water tank 3 and pushes it into the water room 1a through the water inlet 20. The water in the water room la absorbs heat of the motor body 1 and goes back to the cooling water tank 3 to finish a cycle.

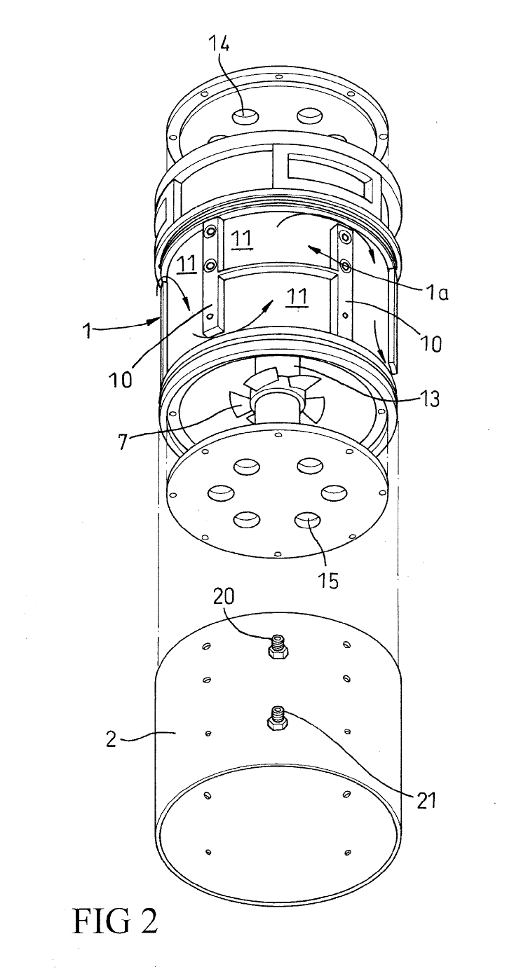

As cab been seen in FIG. 2, there are a plurality of guiding plates 10 arranged in the water room 1a. In the preferred embodiment shown in FIG. 2, the guiding plates 10 are fixed on the motor body 1. A passage 11 for cooling water is formed between any two adjacent guiding plates 10. The water inlet 20, water outlet 21 and passages 11 constitute a loop for allowing cooling water to enter the water room 1a through the water inlet 20 and then to leave through the water outlet 21 swimmingly. In other words, the cooling water swimmingly flows over the motor body 1 to uniformly absorb heat of the motor body 1.

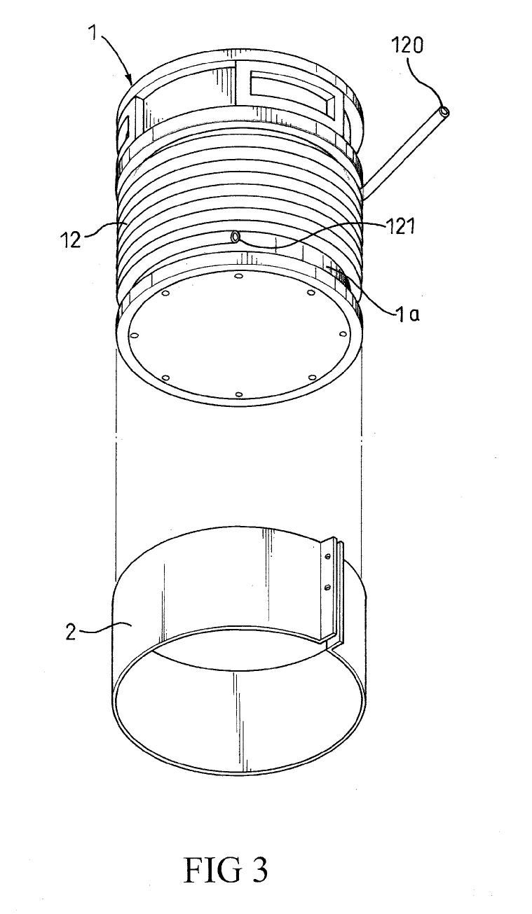

FIG. 3 shows another preferred embodiment. In this embodiment, the water room 1a is provided with a pipe 12 spirally around the motor body 1. The pipe 12 has two ends 120 and 121 connecting with the water inlet 20 and water outlet 21 respectively. The pipe 12 is made of copper, which has great thermo-conductivity. When the motor working, the pump 4 draws water from the cooling water tank 3 and pushes it into the pipe 12 through the water inlet 20. Water flowing in the pipe 12 absorbs heat from the motor body 1 through the pipe 12. Temperature of the motor body 1 can be lowered by the water cooling manner. Then the water in the pipe 12 flows to the cooling water tank 3 for circulatory use.

Referring back to FIG. 1, a temperature sensor 6 can be preferredly arranged between the cooling water tank 3 and water inlet 20, by which temperature of cooling water passing through the water inlet 20 can be obtained. Effect of heat dissipation of the motor will worsen if temperature of the cooling water is too high. An abnormality signal will be sent from the temperature sensor 6 to the cooling water tank 3 for further processing. However, the details of said further processing will not be described here because it does not belong to the field of the invention.

Further referring back to FIG. 2, to improve effect of heat dissipation of the motor, a fan 7 is preferredly fixed at a shaft 13 of the motor body 1. And the motor body 1 is provided with an air inlet 14 and an air outlet 15 which are separately arranged near two ends of the shaft 13. Thus the fan 7 can be driven to rotate by the shaft 13. By rotation of the fan 7, outside air can be guided into the motor to absorb a part of heat generated from the motor for dissipation, and then the heated air is ejected through the air outlet 15. The air cooling and water cooling can form a complex cooling mechanism to further improve effect of heat dissipation.

While the forgoing is directed to various embodiments of the present invention, other and further embodiments of the invention may be devised without departing from the basic scope thereof. As such, the appropriate scope of the invention is to be determined according to the claims.

What is claimed is:

1. A motor with heat dissipation arrangement comprising:
a motor body;
a housing sealedly covering the motor body, wherein the housing is provided with a water outlet and a water inlet;
a cooling water tank; and
a pump arranged between the water inlet and cooling water tank;
wherein a water room is provided between the motor body and housing, and a loop is formed by the water room, the cooling water tank and external pipes;
thereby the pump draws water from the cooling water tank and pushes it into the water room through the water inlet to absorb heat of the motor body.

2. The motor with heat dissipation arrangement of claim 1, wherein the water room is provided with a plurality of guiding plates, a passage is formed between two adjacent guiding plates.

3. The motor with heat dissipation arrangement of claim 1, wherein the water room is provided with a pipe spirally around the motor body, the pipe has two ends connecting with the water inlet and water outlet separately.

4. The motor with heat dissipation arrangement of claim 1, further comprising a temperature sensor arranged between the cooling water thank and the water inlet.

5. The motor with heat dissipation arrangement of claim 2, further comprising a temperature sensor arranged between the cooling water thank and the water inlet.

6. The motor with heat dissipation arrangement of claim 3, further comprising a temperature sensor arranged between the cooling water thank and the water inlet.

7. The motor with heat dissipation arrangement of claim 1, further comprising a fan fixed at a shaft of the motor body, and an air inlet and an air outlet disposed in the motor body near two ends of the shaft.

8. The motor with heat dissipation arrangement of claim 2, further comprising a fan fixed at a shaft of the motor body, and an air inlet and an air outlet disposed in the motor body near two ends of the shaft.

9. The motor with heat dissipation arrangement of claim 3, further comprising a fan fixed at a shaft of the motor body, and an air inlet and an air outlet disposed in the motor body near two ends of the shaft.

10. The motor with heat dissipation arrangement of claim 4, further comprising a fan fixed at a shaft of the motor body, and an air inlet and an air outlet disposed in the motor body near two ends of the shaft.
